(19) United States
(12) Patent Application Publication
(10) Pub. No.: US 2015/0081426 A1
(43) Pub. Date: Mar. 19, 2015

(54) DETERMINING AND COMMUNICATING EXCESS ADVERTISER DEMAND INFORMATION TO USERS, SUCH AS PUBLISHERS PARTICIPATING IN, OR EXPECTED TO PARTICIPATE IN, AN ADVERTISING NETWORK

(71) Applicant: Google Inc., Mountain View, CA (US)

(72) Inventor: Hunter Walk, San Francisco, CA (US)

(73) Assignee: Google Inc., Mountain View, CA (US)

(21) Appl. No.: 14/132,643

(22) Filed: Dec. 18, 2013

Related U.S. Application Data
(63) Continuation of application No. 11/699,599, filed on Jan. 29, 2007, now abandoned.

(51) Int. Cl. G06Q 30/02

(52) U.S. Cl. CPC G06Q 30/0249
USPC 705/14.48

(57) ABSTRACT

Excess advertiser demand may be determined and information regarding the determined excess advertiser demand may be communicated to a user, such as a publisher. The advertising network might be an online advertising network that serves ads relevant to content. Excess advertiser demand in an advertising network might be determined by (a) estimating or determining unspent advertiser budgets, (b) aggregating the unspent advertiser budgets, and (c) determining advertiser desired concept opportunities using the aggregated unspent advertiser budget. Information regarding the determined excess advertiser demand might be communicated toward a client device for presentation to a user by forwarding the determined advertiser desired concept opportunities to the client device for presentation.

### §1. BACKGROUND OF THE INVENTION

§1.1 Field of the Invention

The present invention concerns advertising networks, such as online advertising networks for example.

§1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords™ advertising system by Google, Inc. of Mountain View, Calif. (referred to as “Google”), delivers ads targeted to keywords from search queries. Similarly, content targeted ad delivery systems have been proposed. For example, U.S. patent application Ser. No. 10/314,427 (incorporated herein by reference in its entirety and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference in its entirety and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense™ advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular.

Regardless of whether or how ads are targeted, an advertiser typically compensates the content owner (referred to more generally as a “document publisher” or “Web publisher”) and perhaps an ad serving entity. Such compensation may occur whenever the ad is served (per impression), or may be subject to a condition precedent such as a selection, a conversion, etc. Compensation per selection (commonly referred to as “pay per click”) is currently becoming popular. For example, when a user selects an ad, they are typically brought to (e.g., their browser loads) a corresponding ad landing page linked from the ad. The advertiser compensates the Web publisher for the selection.

Although services such as Google's AdSense™ have enabled Web publishers to obtain advertising revenue, publishers are often unable to efficiently estimate what advertising dollars are available for placement in their media or what content their users are ultimately looking for. That is, publishers often create content based upon speculated or demonstrated interest from advertisers with the goal of attracting available ad dollars and interested consumers. However techniques of estimating advertiser and consumer interest, available to publishers, are inexact, potentially leading to sub-optimal decisions regarding the type of content that a publisher creates.

For example, a publisher of a travel Website might run an article on South American casinos, not knowing that all the South American casinos (likely advertisers for this editorial who would pay for exposure to readers clearly interested in South American travel) have exhausted their advertising budget for the year. Thus, if the travel Website runs such content, it will likely find only more general advertisers who aren't willing to pay a premium for exposure to these readers. And the ads from such advertisers will be less relevant to the publisher's consumers. The less relevant ads will further depress performance as uninterested consumers ignore the advertising.

As another example, in the reverse, the travel Website might not know that a scuba gear company has money left in their marketing budget with the desire to pay a premium to reach readers interested in scuba gear. Thus, the travel Website might write an article on hotels in Paris when both the publisher and the publisher's consumers might be better served if the publisher commissioned a freelance writer to develop an article on scuba gear instead.

In each of the foregoing examples, assuming equal readership for both types of content, because of imperfect information regarding advertiser demand, the publisher has earned less in advertising revenue than was available to it and the consumer of the publication has received less relevant advertisements.

In view of the foregoing, it would be useful to assist publishers, such as Web publishers for example, to better understand advertiser demand, and in particular excess advertiser demand.

### §2. SUMMARY OF THE INVENTION

Embodiments consistent with the present invention may be used to assist publishers, such as Web publishers for example, to better understand advertiser demand, and in particular excess advertiser demand. If content publishers had access to generalized real-time information about available advertising budgets and the content they believe would attract qualified consumers, they could make more economically rational decisions, thereby improving the intersection of user interest and advertiser spending. Embodiments consistent with the present invention might do so by (a) determining excess advertiser demand in an advertising network, and (b) communicating information regarding the determined excess advertiser demand toward a client device for presentation to a user.

In at least some embodiments consistent with the present invention, the advertising network is an online advertising network that serves ads relevant to content.

In at least some embodiments consistent with the present invention, excess advertiser demand in an advertising network may be determined by (a) estimating or determining unspent advertiser budgets, (b) aggregating the unspent advertiser budgets, and (c) determining advertiser desired concept opportunities using the aggregated unspent advertiser budget.

In at least some embodiments consistent with the present invention, information regarding the determined excess advertiser demand may be communicated toward a client device for presentation to a user by forwarding the determined advertiser desired concept opportunities to the client device for presentation.

### §3. BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIG. 3 is a bubble diagram illustrating exemplary operations that might be performed in an embodiment consistent with the present invention, as well as information that may be used and/or generated by such operations.

FIG. 4 is a flow diagram of an exemplary method for determining and communicating excess advertiser demand to users, such as publishers participating in, or expected to participate in, an online advertising network, in a manner consistent with the present invention.

FIG. 5 is a flow diagram of an exemplary method for determining excess advertiser demand in an advertising network in a manner consistent with the present invention.

FIG. 6 is a block diagram of apparatus that might be used to perform at least some operations, and store at least some information, in a manner consistent with the present invention.

FIG. 7 is an example illustrating operations in an exemplary embodiment consistent with the present invention.

FIG. 8 is an exemplary system consistent with the present invention.

### §4. DETAILED DESCRIPTION

The present invention may involve novel methods, apparatus, message formats, and/or data structures for determining and communicating excess advertiser demand to users (e.g., publishers participating in, or expected to participate in, an online advertising network). The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventor regards his invention to include any patentable subject matter described.

In the following, definitions of terms that may be used in the specification are provided in §4.1. Then, environments in which, or with which, the present invention may operate are described in §4.2. Exemplary embodiments of the present invention are described in §4.3. Thereafter, specific examples illustrating uses of exemplary embodiments of the present invention are provided in §4.4. Finally, some conclusions regarding the present invention are set forth in §4.5.

### §4.1 DEFINITIONS

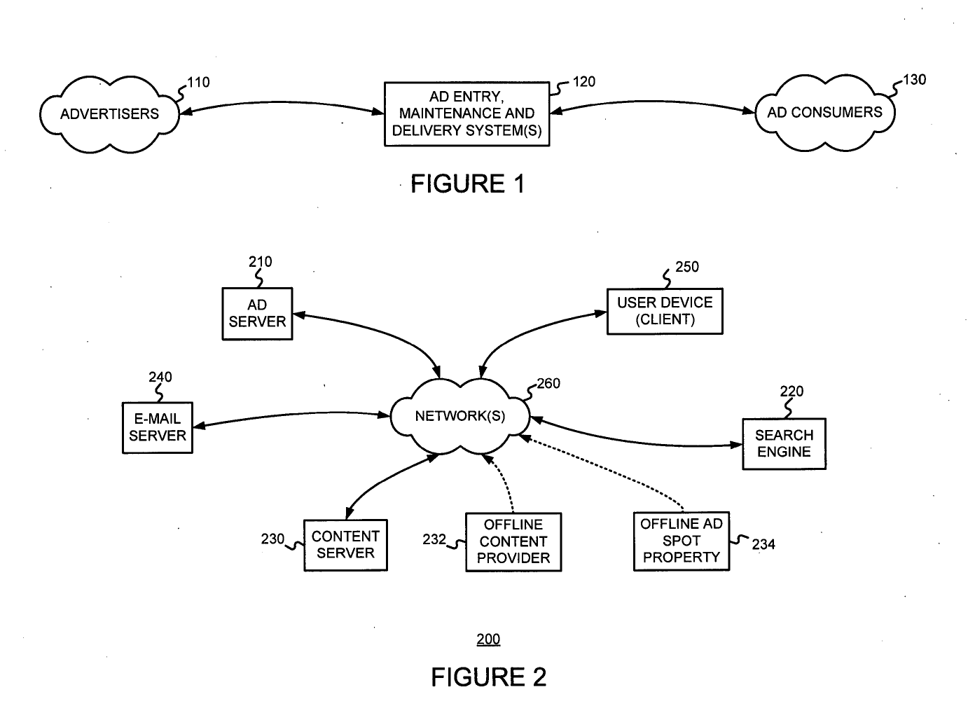

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered into an advertising system the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner. A “document publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### §4.2 EXEMPLARY ADVERTISING ENVIRONMENTS IN WHICH, OR WITH WHICH, EMBODIMENTS CONSISTENT WITH THE PRESENT INVENTION MAY OPERATE

FIG. 1 is a diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities. Network(s) 260 may be used to interconnect the various servers/devices described above. Such network(s) 260 may illustratively include the Internet or private networks.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant to the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference in their entirety). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Additionally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### §4.3 EXEMPLARY EMBODIMENTS

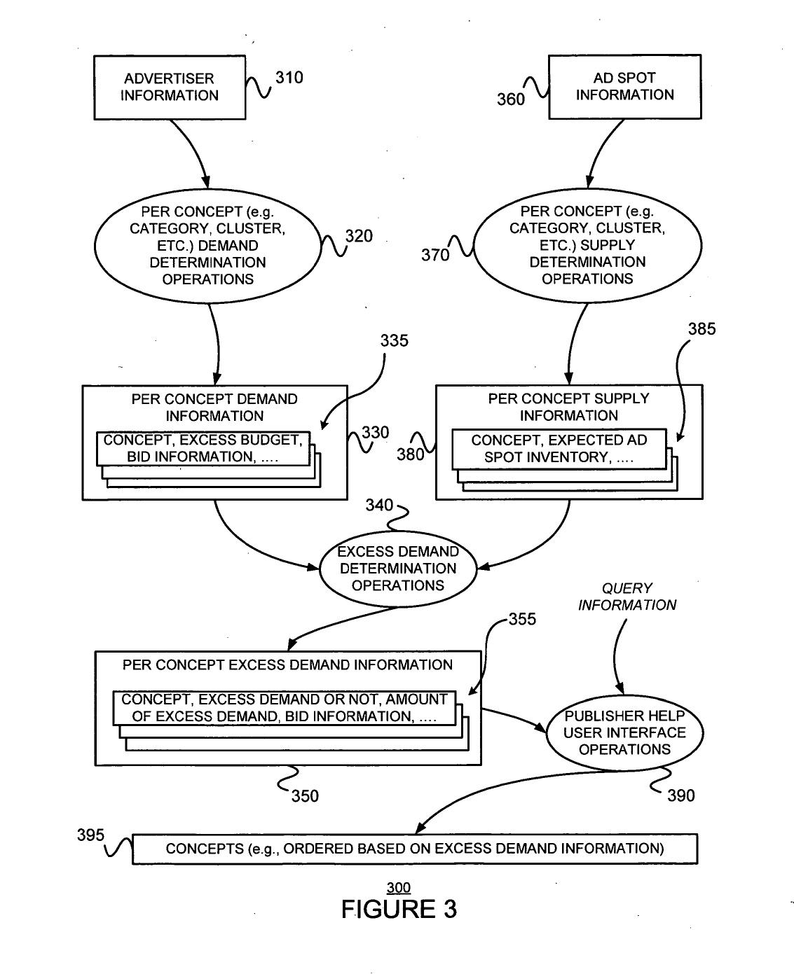

FIG. 3 is a bubble diagram illustrating exemplary operations 300 that might be performed in an embodiment consistent with the present invention, as well as information that may be used and/or generated by such operations. Generally, advertiser information 310 is matched against ad spot information 360, in order to identify mismatches in ad supply versus advertiser demand, so that publishers and ad server entities can take advantage of these mismatches to enhance the placement and performance of ads served on documents.

In order to accomplish this, in one embodiment of the present invention the advertiser information 310, including ad budgets, bid information, ad concepts, etc., are organized by operations 320 by concept (e.g. category, cluster, etc.) demand, resulting in “per concept” demand information 330. Such information 330 might include such items 335 such as the excess budget and bid information for each concept.

In addition, ad spot information 360 might be organized by supply determination operations 370 by concept (e.g. category, cluster, etc.), resulting in “per concept” supply information 380, such information 380 might include items 385 such as the expected ad spot inventory for each concept, etc.

The excess budget and/or bid information 335 for a concept is then matched with the expected ad spot inventory 385 for the concept by excess demand determination operations 340, resulting in “per concept” excess demand information 350. Such information 350 might include items 355 for each concept such as whether there is excess demand (or not), amount of excess demand, bid information, etc. This information, correlated by concept (e.g., category, cluster, etc.), might be searched using query information, such as publisher requests, ideas, suggestions, etc., by publisher help user interface operations 390. Such operations 390 might use this information to generate concepts 395 for which there is excess advertiser budget. The concepts 395 could advantageously be sorted in order of decreasing excess demand information for each concept.

In this way, publishers could more readily match their document concepts to advertisers' desires and budget constraints, resulting in both more advertiser spending and greater usefulness of served ads.

### §4.3.1 Exemplary Methods

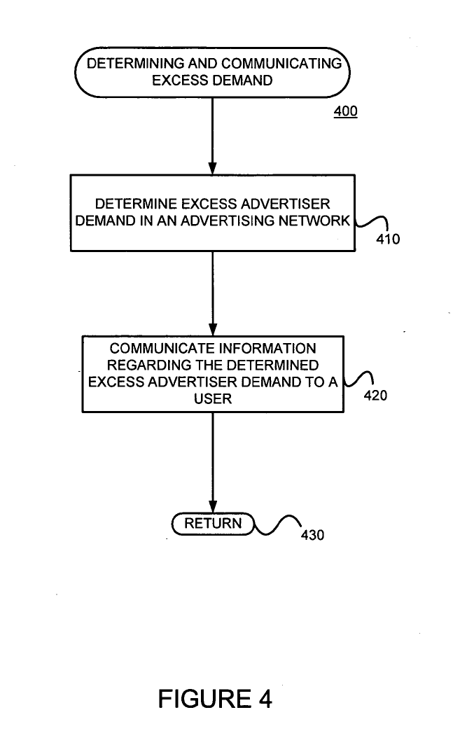

FIG. 4 is a flow diagram of an exemplary method 400 for determining and communicating excess advertiser demand to publishers participating in an online advertising network in a manner consistent with the present invention.

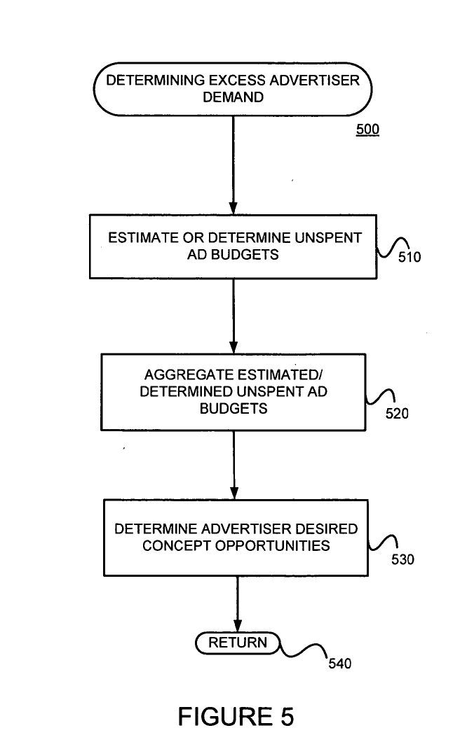

Excess advertiser demand in a given advertising network is determined. (Block 410). Typically, the advertising network is online and content-targeted. Exemplary methods for performing this act are described below in relation to FIG. 5. Then information regarding the determined excess advertiser demand is communicated to a user. (Block 420) This might include forwarding to users (such as publishers or other content providers or owners participating in the advertising network) the concepts desired by advertisers for which there is, or for which there is expected to be, insufficient ad spots. This information represents opportunities for a user to publish documents directed to these desired concepts, thereby enhancing the expected revenue stream generated for such content by advertisements. Advantageously, the users could be registered for participation in the advertising network, thereby providing some control over information transfer to users, as well as opportunities for revenue to the advertising network agents from the users.

Once this information has been communicated to the users, the method 400 is left. (Node 430) Note that as new content is provided on the network, the method 400 might be repeated.

FIG. 5 is a flow diagram of an exemplary method 500 for determining excess advertiser demand in an advertising network in a manner consistent with the present invention. The method 500 might be run multiple times for multiple different concepts. Unspent ad budgets are estimated or determined. (Block 510) This might include determining an anticipated unspent advertiser budget per advertiser using such inputs as the advertiser's historical advertising expenditures, the volume of impressions for concepts targeted by the advertiser, the volume of selections for the concepts so targeted, and/or the volume of conversions for the concepts. The concepts might be keywords, categories, etc. The estimated/determined unspent advertiser budgets are then aggregated. (Block 520) This might be accomplished by summing the estimated/determined unspent advertiser budgets into, for example, product verticals and/or service verticals, or product categories and/or service categories, or some other categorizations that might be useful to provide to content providers as an indication of financially beneficial subject matter. Finally advertiser desired concept opportunities are determined using the aggregated unspent ad budgets. One way of accomplishing this would be to generate an expected revenue per page view for each of a plurality of concepts. The concepts might include categories or verticals for example.

Note that in some embodiments consistent with the present invention, if only a global (e.g., ad campaign level) budget is available, the unspent budget might be indicated as being available to any of the targeted concepts (e.g., vertical categories). Thus, an advertiser's unspent budget might be applied to any applicable (e.g., relevant or targeted) concept (e.g., vertical category). For example, if the unspent budget for an ad targeted to (or is relevant to) concepts A and B is $100.00, it might be indicated that an unspent $100.00 is available in concept A and an unspent $100.00 is available in concept B. The unspent budget can be updated (e.g., in real time) as those categories draw down from the unspent budget. However, in some embodiments consistent with the present invention, if it is desired to show total available budget in more than one concept at once, the total available budget may be apportioned over the concepts. In such embodiments, an advertiser's unspent budget might be apportioned to a number of concepts to which the ad is targeted (or relevant) as a function of ad targeting criteria, relative ad relevance to the concepts, ad criteria offer information (e.g., price/impression, price/selection, price/conversion, maximum price/impression, maximum price/selection, maximum price/conversion, etc.), and/or criteria ad performance information (e.g., selection rate, conversion rate, etc.).

One beneficial approach to determining per concept excess demand information based upon unspent ad budgets would be to generate an expected revenue stream for each concept, using advertiser offers per action related to the concept along with estimated action rates for the concepts, estimated page views for the concepts, and advertiser budgets for those concepts. Again, these concepts could be categories, verticals, etc. The subject actions again could be ad selection and/or ad conversion rates.

Another beneficial approach to assisting a content provider to discover excess advertiser demand would be to rank order the determined advertiser concept opportunities, such as in descending order of unspent budgets, and providing this information to content providers or other users. The order could be based on total available revenue, expected revenue per page view, expected revenue per ad spot impression, etc., to name a few of the possible approaches to the presentation of such information.

In some cases embodiments consistent with the present invention, this ordering of information for presenting to users such as content providers could then be advantageously updated using more current information.

In some embodiments consistent with the present invention, the user could provide a value threshold or range, so that the advertiser desired concept opportunities could be filtered, using the value thresholds or ranges. Then, only opportunities that met the particular user's criteria would be forwarded to that user.

### §4.3.2 Exemplary Apparatus

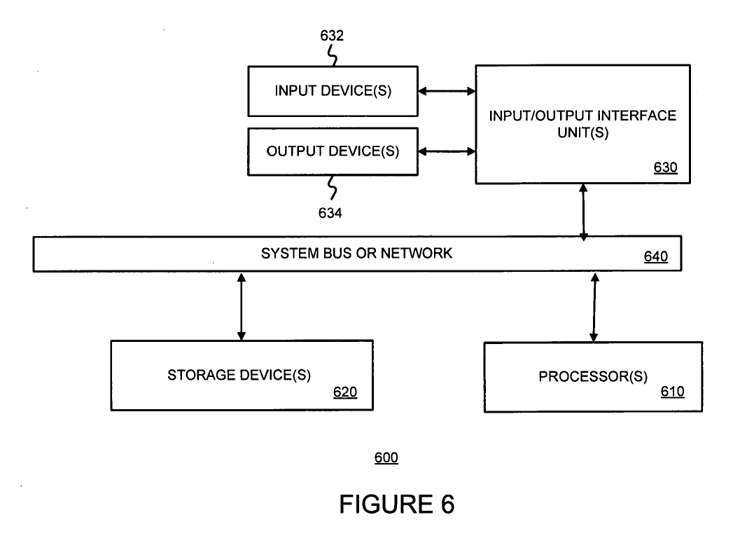

FIG. 6 is a block diagram of apparatus 600 that may be used to perform at least some operations, and store at least some information, in a manner consistent with the present invention. The apparatus 600 basically includes one or more processors 610, one or more input/output interface units 630, one or more storage devices 620, and one or more system buses and/or networks 640 for facilitating the communication of information among the coupled elements. One or more input devices 632 and one or more output devices 634 may be coupled with the one or more input/output interfaces 630.

The one or more processors 610 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. For example, one or more software modules, when executed by a processor, may be used to perform one or more of the operations of FIG. 3, and/or the acts of FIGS. 4 and 5. At least a portion of the machine executable instructions may be stored (temporarily or more permanently) on the one or more storage devices 620 and/or may be received from an external source via one or more input interface units 630.

In one embodiment, the machine 600 may be one or more conventional personal computers or servers. In this case, the processing units 610 may be one or more microprocessors. The bus 640 may include a system bus. The storage devices 620 may include system memory, such as read only memory (ROM) and/or random access memory (RAM). The storage devices 620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 610 through an appropriate interface 630 coupled to the system bus 640. The output devices 634 may include a monitor or other type of display device, which may also be connected to the system bus 640 via an appropriate interface. In addition to (or instead of) the monitor, the personal computer may include other (peripheral) output devices (not shown), such as speakers and printers for example.

The operations described above may be performed on one or more computers. Such computers may communicate with each other via one or more networks, such as the Internet for example. Referring back to FIG. 3 for example, the various operations and information may be embodied by one or more machines 600.

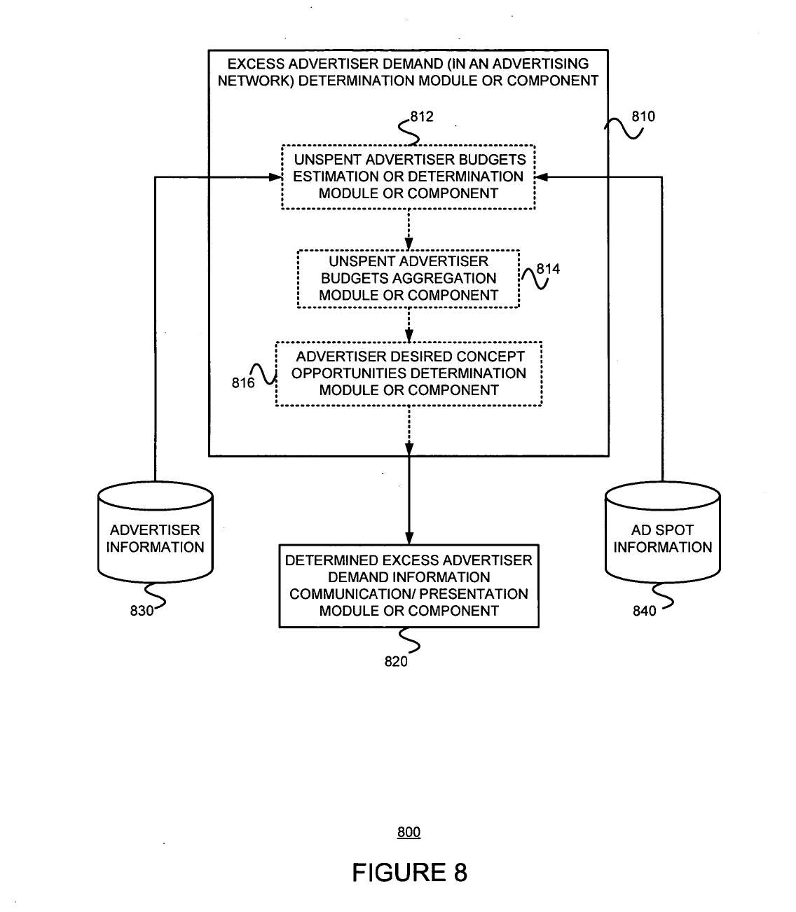

FIG. 8 is an exemplary system 800 that may be used to perform at least some operations in a manner consistent with the present invention. Excess advertiser demand in a given advertising network is determined by module or component 810. The information regarding the determined excess advertiser demand is provided to module or component 820 which communicates or presents it to a user.

In some embodiments consistent with the present invention, the module or component 810, may include (1) a module or component 812 for determining or estimating unspent ad budgets, (2) a module or component 814 for aggregating the estimated/determined unspent advertiser budgets, and (3) a module or component 816 for determining advertiser desired concept opportunities. As shown, the module or component 812 may use advertising information 830 and ad spot information 840.

In some embodiments consistent with the present invention, the module or component 820 may be a front-end user interface which allows a user to access the determined excess advertiser demand information. This may be presented to the user in various ways, such as per vertical category, ordered based on amount of unspent demand, ordered based on estimated per impression value of ad spots, etc. In some embodiments consistent with the present invention, one or more attributes of the excess advertiser demand information may be searched, filtered, etc.

The modules or components may be machine-executed software code (e.g., machine executed program instructions), and/or hardware. The modules or components may perform various acts and/or operations described above with reference to FIGS. 3-5.

### §4.3.3 Refinements, Alternatives and Extensions

Various levels of detail could be provided to users (such as publishers or other content providers) within the scope of this invention. For instance, estimated cost per impression (eCPM) for advertisers within the selected verticals representing unspent ad budgets could be provided, specific keywords associated with unspent ad budgets could be provided, or sub-categories of verticals could be provided according to projected unspent budgets within those sub-categories.

In some embodiments consistent with the present invention, the details pertaining to designated verticals or categories could be provided to only those users whose publications involve those verticals. This might help to inhibit spamming-type activities.

As generally described above, the provided information could be ordered in various ways, such as in descending levels of unspent budgets, threshold limits placed on reported unspent amounts, etc.

### §4.4 EXAMPLE OF OPERATIONS IN AN EXEMPLARY EMBODIMENT CONSISTENT WITH THE PRESENT INVENTION

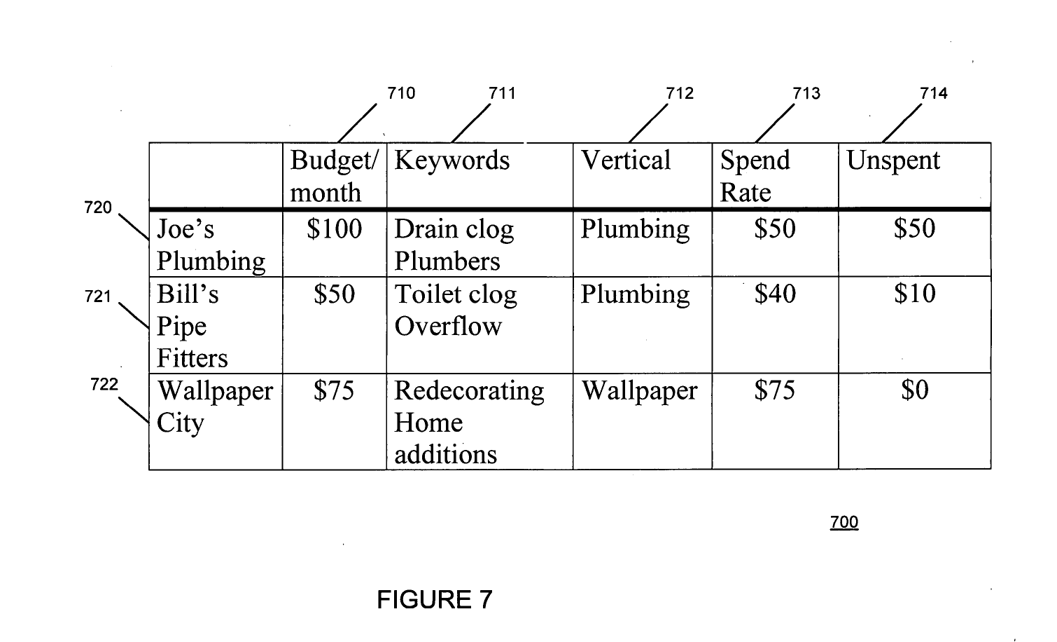

As an illustrative example of operations in an embodiment consistent with the present invention, it is assumed that three advertisers' typical spend rates and budgets are known, as depicted on FIG. 7.

Amounts of “unspent” advertiser budget are determined and aggregated into verticals (concepts). This might then be converted into an “anticipated unspent advertiser budget” per vertical based upon their historical expenditures, such as within AdSense, and the overall volume of impressions, for the selections, and/or conversions concepts targeted.

Advertiser Joe's Plumbing 720 is willing to spend $100/month (Column 710) via content targeting, targeting keyword concepts such as “drain clog” and “plumbers” (Column 711). Historically they've only been able to spend $50/month (Column 713). These ads are categorized (using verticals) as being in the “Plumbing” vertical (Column 712). The result is an anticipated $50 unspent per month (Column 714).

Advertiser Bill's Pipe Fitters 721 is willing to spend $50/month (Column 710) via content targeting but has only been able to generate a $40/month Spend Rate (Column 713). Bill's Pipe Fitters 721 is targeting concepts such as “toilet clog” and “overflow” (Column 711). This vertical is also “Plumbing” (col 712), and results in an unspent amount of $10 per month (Column 714).

Finally advertiser Wallpaper City 722 is willing to spend $75/month (Column 710) via content targeting and routinely spends their entire budget (Column 713) by the third week of each month. Therefore, their unspent amount per month (Column 714) is $0. (Indeed, the unspent amount might be a negative value, indicating an excess supply of ad spots.) They use keywords such as “redecorating” and “home additions” (Column 711), and are classified as being in the “Wallpaper” vertical (Column 712).

The “likely unspent” dollars might be aggregated into content categories, or verticals. “Plumbing” has a “likely unspent” value of $60 from the two advertisers (Column 714, in rows 720 and 721). “Wallpaper” has a “likely unspent” value of $0 from one advertiser (Column 714 in row 722).

The “highest value opportunities” might be determined next. Using advertiser's bid CPCs (cost per click on one of their ads) and page CTRs (click through rates per ad shown) for the content categories, an eCPM (expected cost per thousand ads (and therefore ad spots) shown) for each of the “likely unspent” categories (verticals) is determined. It should be noted that “cost” to the advertiser generally equates to “revenue” to the publisher.

Since it is known that the “Plumbing” vertical has an average cost per click (CPC) bid of $1 and a CTR of 2%, 1,000 ad impressions would be expected to generate $20 (gross revenue to the publisher; “cost” to the advertiser). Although the “Wallpaper” vertical might have a calculated eCPM of $30, for example, since there is no projected “likely unspent” value, the $30 estimate would be devalued or ignored.

If another vertical, say “Furniture”, was calculated to have a “likely unspent” amount of $90, but an eCPM of $15, it may be ranked behind the “Plumbing” vertical in desirability to publishers. Conversely, if the “Windows” vertical was calculated to have a projected “likely unspent” amount of $25, but an eCPM of $35, it might be ranked first in terms of publisher desirability. Without the eCPM input, the concepts might be ranked simply by “likely unspent” gross amounts in each vertical. Therefore, the eCPM alternatively may or may not be provided to the publishers, yielding different publisher decisions. Further, the ratio of “likely unspent” to eCPM could be used by publishers in making decisions about concepts in their content to be published.

Another alternative approach would be to allow the publishers to provide preset eCPM thresholds or ranges (e.g., <$10, $10-$50, >$50, etc.), in order to filter the opportunities presented to them, without learning in detail what the eCPMs were for any given vertical or category.

After viewing the vertical areas with greatest advertising potential, publishers may choose to orient their upcoming content towards those areas in order to maximize their return on investment on ad space. For instance, a home décor publisher might log into an Ad-Serving System Front End (ASFE) and discover that within the “Home and Garden” vertical “Plumbing” is an advertiser-friendly content category this month, while “Wallpaper” is not. Using this information the home décor publisher might write an article entitled “10 Easy Plumbing Fixes.” “Plumbing” advertisements might be automatically matched against this new available inventory via an ad-serving system that provides ads that are relevant to content. Each new click on an advertiser's ad feeds back to the calculation of their “likely unspent” budget. Eventually advertising verticals that were “likely unspent” might fall off the opportunity list as distribution and ad clicks increase.

### §4.5 CONCLUSIONS

Advertisers are often unable to spend their entire marketing budgets for lack of suitable media inventory. For example, a scuba gear company might seek to spend $1,000 placing their ads on sites about scuba gear, but only find enough relevant web pages to place $750 worth of ads—the remaining $250 goes unspent. By giving (e.g., online and/or offline) publishers generalized insight into unmet advertiser demand, embodiments consistent with the present invention allow them to more efficiently direct their content creation or acquisition towards inventory suitable for available advertisements. This increases publisher revenue, helps advertisers meet their marketing goals, and provides the publisher's consumers with ads that are more relevant to the publisher's content.

What is claimed is:

1-31. (canceled)

32. A method for identifying unmet advertiser demand, comprising:
determining for each of a plurality of advertisers, by a device, an unspent advertising budget and an associated advertising concept;
aggregating, by the device, each unspent advertising budget associated with the same advertising concept to generate an excess advertiser demand value for the advertising concept;
determining, by the device, an estimated cost per impression for the advertising concept;
identifying, by the device, that the aggregated excess demand value exceeds the estimated cost per impression; and
communicating, by the device to a content provider, an identification of an advertising opportunity associated with the advertising concept, responsive to the identification.

33. The method of claim 32, wherein determining an unspent advertising budget for an advertiser further comprises:
determining, for each of a plurality of advertising concepts, an anticipated unspent advertiser budget per advertiser based on the advertiser's historical advertising expenditures.

34. The method of claim 32, wherein determining an unspent advertising budget for an advertiser further comprises:
determining, for each of a plurality of advertising concepts, a volume of impressions for the advertising concept targeted by the advertiser.

35. The method of claim 32, wherein determining an unspent advertising budget for an advertiser further comprises:
determining, for each of a plurality of advertising concepts, a volume of selections for the advertising concept targeted by the advertiser.

36. The method of claim 32, wherein determining an unspent advertising budget for an advertiser further comprises:
determining, for each of a plurality of advertising concepts, a volume of conversions for the advertising concept targeted by the advertiser.

37. The method of claim 32, wherein the act of determining an unspent advertising budget further comprises:
retrieving an offer per action of the advertiser related to the associated advertising concept;
determining an estimated action rate for the advertising concept; and
calculating an unspent advertising budget proportional to the offers per action multiplied by the estimated action rate.

38. The method of claim 32, wherein determining an estimated cost per impression for the advertising concept further comprises calculating an estimated cost per impression proportional to the estimated action rate multiplied by an average advertiser bid.

39. A system for identifying unmet advertiser demand, comprising:
a device comprising a processor, the processor configured for:
determining for each of a plurality of advertisers an unspent advertising budget and an associated advertising concept,
aggregating each unspent advertising budget associated with the same advertising concept to generate an excess advertiser demand value for the advertising concept,
determining an estimated cost per impression for the advertising concept,
identifying that the aggregated excess demand value exceeds the estimated cost per impression, and
communicating, to a second device of a content provider, an identification of an advertising opportunity associated with the advertising concept, responsive to the identification.

40. The system of claim 39, wherein the processor is further configured for:
determining, for each of a plurality of advertising concepts, an anticipated unspent advertiser budget per advertiser based on the advertiser's historical advertising expenditures.

41. The system of claim 39, wherein the processor is further configured for:
determining, for each of a plurality of advertising concepts, a volume of impressions for the advertising concept targeted by the advertiser.

42. The system of claim 39, wherein the processor is further configured for:
determining, for each of a plurality of advertising concepts, a volume of selections for the advertising concept targeted by the advertiser.

43. The system of claim 39, wherein the processor is further configured for:
determining, for each of a plurality of advertising concepts, a volume of conversions for the advertising concept targeted by the advertiser.

44. The system of claim 39, wherein the processor is further configured for:
retrieving an offer per action of the advertiser related to the associated advertising concept;
determining an estimated action rate for the advertising concept; and
calculating an unspent advertising budget proportional to the offers per action multiplied by the estimated action rate.

45. The system of claim 39, wherein the processor is further configured for calculating an estimated cost per impression proportional to the estimated action rate multiplied by an average advertiser bid.

46. A computer-readable storage medium storing instructions that when executed by one or more data processors, cause the one or more data processors to perform operations comprising:
determining for each of a plurality of advertisers an unspent advertising budget and an associated advertising concept,
aggregating each unspent advertising budget associated with the same advertising concept to generate an excess advertiser demand value for the advertising concept,
determining an estimated cost per impression for the advertising concept,
identifying that the aggregated excess demand value exceeds the estimated cost per impression, and
communicating, to a second device of a content provider, an identification of an advertising opportunity associated with the advertising concept, responsive to the identification.

47. The computer-readable medium of claim 46, wherein the medium further includes instructions to cause the one or more data processors to:
determine, for each of a plurality of advertising concepts, an anticipated unspent advertiser budget per advertiser based on the advertiser's historical advertising expenditures.

48. The computer-readable medium of claim 46, wherein the medium further includes instructions to cause the one or more data processors to:
determine, for each of a plurality of advertising concepts, a volume of impressions for the advertising concept targeted by the advertiser.

49. The computer-readable medium of claim 46, wherein the medium further includes instructions to cause the one or more data processors to:
determine, for each of a plurality of advertising concepts, a volume of impressions for the advertising concept targeted by the advertiser.

50. The computer-readable medium of claim 46, wherein the medium further includes instructions to cause the one or more data processors to:
retrieve an offer per action of the advertiser related to the associated advertising concept;
determine an estimated action rate for the advertising concept; and
calculate an unspent advertising budget proportional to the offers per action multiplied by the estimated action rate.

51. The computer-readable medium of claim 46, wherein the medium further includes instructions to cause the one or more data processors to calculate an estimated cost per impression proportional to the estimated action rate multiplied by an average advertiser bid.
